(19) United States
(12) Patent Application Publication
(10) Pub. No.: US 2013/0094325 A1
(43) Pub. Date: Apr. 18, 2013

(54) LOOK-AHEAD SEISMIC WHILE DRILLING

(71) Applicants: Albena Alexandrova Mateeva, Houston, TX (US); Kurang Jvalant Mehta, Houston, TX (US); Maria Tatanova, Peterhof St.Petersburg (RU)

(72) Inventors: Albena Alexandrova Mateeva, Houston, TX (US); Kurang Jvalant Mehta, Houston, TX (US); Maria Tatanova, Peterhof St.Petersburg (RU)

(21) Appl. No.: 13/704,304

(22) PCT Filed: Jun. 15, 2011
(86) PCT No.: PCT/US11/40531

§ 371 Date: Dec. 14, 2012

Related U.S. Application Data
(60) Provisional application No. 61/355,215, filed on Jun. 16, 2010.

(51) Int. Cl. G01V 1/48; E21B 49/00

(52) U.S. Cl. CPC G01V 1/48; E21B 49/006
USPC 367/35

(57) ABSTRACT

A method of evaluating a formation of interest, comprises collecting a data set comprising signals received at a plurality of receivers signals from a source on a bottom-hole assembly at a position in a borehole, processing the data set so as to create a virtual trace received at a virtual receiver located at the source position, and using the virtual trace to generate an image or measurement containing information about the formation of interest. The source may or may not be a drill bit and the data can be collected at several different source positions.

### RELATED CASES

Not applicable.

### FIELD OF THE INVENTION

The invention relates to a technique for vertical seismic profiling in which the source is located in the borehole and a virtual receiver is created at the location of the source where there is no physical receiver.

### BACKGROUND OF THE INVENTION

In drilling operations where the objective is the location of hydrocarbons for production, it is advantageous to detect the presence of a formation anomaly (acoustic reflector) ahead of or around a drill bit or bottom hole assembly. An acoustic reflector is any interface in the formation where there is a change in acoustic impedance. Examples of anomalies that can be detected include over-pressured zones, faults, cracks, or cavities, salt structures, boundaries between different sedimentary formations, and zones permeated with different fluids or gases.

Information about subsurface formations can be gathered using various seismic techniques. Typically, before the drilling starts, a surface seismic survey has been acquired. In a surface seismic survey, both sources and receivers are positioned at or near the surface. This is the most widely-used type of geophysical survey, but is hampered by noise, interference, and attenuation that occur near the surface. The seismic source may be a mechanical wave generator, an explosive, or an air gun. The source generates waves that reflect from the formations of interest and are detected by the receivers, which may incorporate sensors such as geophones, accelerometers, or hydrophones that measure phenomena such as particle velocity, acceleration, or fluid pressure. Seismic survey equipment synchronizes the sources and receivers, records a pilot signal representative of the source, and records reflected waveforms that are detected by the receivers. The data is processed to graphically display the time it takes seismic waves to travel between the surface and each subterranean reflector. If the velocity of seismic waves in each subterranean layer can be determined, the position of each reflector can then be established.

Surface seismic data can provide some large-scale velocity information that can be used for the transformation of the subsurface seismic map from the time domain to the spatial domain. However, that information is often uncertain. A more precise velocity model can be obtained from measurements performed in a borehole, typically by lowering instruments into the borehole on a wireline. The measurements can be performed at sonic or seismic frequencies and have, respectively, different depths of investigation. For example, a typical sonic tool can “see” the formation velocity only a few feet away from the borehole. One such tool is disclosed in U.S. Pat. No. 5,678,643 to Robbins, et al. The tool transmits acoustic signals into a wellbore and receives returning acoustic signals including reflections and refractions. Receivers detect the returning acoustic signals and the time between transmission and receipt can be measured. Distances and directions to detected anomalies are determined by a microprocessor that processes the time delay information from the receivers. As mentioned above, the depth of investigation facilitated by the tool is limited.

A deeper investigation can be performed at seismic frequencies, for example by vertical seismic profiling (VSP). VSP uses one or more seismic sources at the surface with one or more receivers deployed in the borehole on a wireline. Reverse vertical seismic profiling (RVSP), also known as inverse seismic profiling (IVSP), uses receivers at the surface with a seismic source deployed on a wireline. Such measurements may also be made in a borehole that deviates from the vertical. In addition to refined velocity information, they can provide a clearer image of some target reflectors, too. The down-side is that VSP/RVSP surveys typically require lengthy and expensive interruption of the drilling process if acquired before the well reaches its target depth

Also known in the art are means for obtaining seismic information from the borehole without interrupting the drilling process by using tools incorporated in the drill string. These methods are known collectively as seismic measurement-while-drilling (seismic MWD), sometimes shortened to “seismic while drilling” (SWD). There are currently two main approaches to seismic while drilling.

In one approach, sometimes called “drill bit seismic”, the drill bit is considered as a seismic source in a RVSP geometry—i.e., the signals from the drill bit are detected at surface receivers and processed as RVSP data. Such a system is illustrated at 10 in FIG. 1 and includes a drill bit 12 positioned in wellbore 14 and a plurality of receivers 16 positioned on the earth's surface 18. Receivers 16 record seismic signals that travel from bit 12 along various paths 22, including paths that include reflection by a subsurface reflector 20. This approach typically requires cross-correlating the detected signals with a “pilot trace” 23 recorded by a receiver 17 near the drill bit in order to remove the complicated and otherwise unknown source signature of the drill bit. Also, it typically requires accurate clock synchronization between downhole devices and the surface. These hardware requirements are not trivial and limit the applicability and usefulness of the RVSP method.

U.S. Pat. No. 4,207,619 discloses use of a seismic pulse generator near the bit. As the bit advances, the seismic pulse generator advances in the well. An array of seismometers, rotationally symmetric about the well, are arranged at the surface to detect pulses refracted above the seismic pulse generator and pulses reflected at interfaces below the generator. U.S. Pat. Nos. 4,363,112 and 4,365,322 also disclose methods for RVSP MWD using the drill bit itself as a seismic source and an array of surface receivers.

More recently, a new class of SWD techniques based on interferometry has emerged. This technique attempts to reconstruct the Green's function between two receivers, which are typically in a nearby borehole, by turning one of them into a virtual source (VS) and “recording” it at the other receiver. The noise from the drill bit provides signal energy for the virtual source. The process of VS creation involves cross-correlating noise records from the two receivers and summing over many drill bit positions (preferably—the entire well). Due to the spatial configuration of the experiment, the resulting virtual traces are typically suitable for imaging steep targets to the side of the drilling and/or observation wells. Variations of this interferometric approach are known.

While currently available techniques are somewhat capable of detecting the presence of a subsurface anomaly, they tend to be more expensive, less accurate, and/or slower than desired. Hence, it remains desirable to provide an effective method for imaging the subsurface ahead of the bit while a well is being drilled without excess expense and in real time.

### SUMMARY OF THE INVENTION

In accordance with preferred embodiments of the invention there is provided an effective method for imaging the subsurface ahead of the bit while a well is being drilled without excess expense and in real or relevant time.

As used in this specification and claims the following terms shall have the following meanings:

The term “earth's surface” refers to the surface of the earth on land, or to the water surface or the seafloor in offshore applications. It will be understood that items that are “at the earth's surface” can be located on the upper surface, buried in a trench, floating below the water surface, or otherwise coupled to the earth, but are not located in a well.

“Virtual source” refers to a locus for which actual seismic data, i.e. seismic signals from an actual source to actual receivers, are measured and mathematically manipulated so as to generate a data set that simulates signals from that locus to the actual receivers, even though there is no actual source at that locus.

“Virtual receiver” refers to a locus for which actual seismic data, i.e. seismic signals from an actual source to actual receivers, are emitted and mathematically manipulated so as to generate a data set that simulates signals from an actual source position to that locus, even though there is no actual receiver at that locus.

When an item is said to be “at the position” or “at the location” of a second item, this phrase means that the first item is at the precise position of the second item, or is close enough to the second item that they can be treated as co-located for the purpose of seismic data processing.

In some embodiments, the invention provides a method of evaluating a formation of interest, using a plurality of seismic receivers and a bottom hole assembly that includes a seismic source and is positioned in a borehole. The method preferably comprises a) receiving signals from the source at the plurality of receivers and collecting a data set comprising the received signal, b) processing the data set so as to create a virtual trace received at a virtual receiver located at the source position, and, optionally, c) repeating steps a)-b) for at least one additional source position in the borehole. The virtual trace(s) can be used to generate an image or measurement containing information about the formation of interest.

The source preferably moves less than 100 feet during step a). In some embodiments, there are no receivers in the same well as the source.

The source may be a drilling tool or a drill bit and the virtual receiver may be at the source position. If the source is a drilling tool or bit, step b) may comprise autocorrelating the data and summing the results of the autocorrelation over a plurality of receiver locations, the formation of interest may lie ahead of the bit or to the side of the bit and time-gating may be used on the received signals to separate the source positions or improve the virtual receiver creation.

In other embodiments, the source is not the drill bit and is an acoustic transmitter on the bottom hole assembly. In these embodiments, time-gating may be used on the received signals to separate the source positions or to improve the virtual receiver creation, step b) may comprise cross-correlating the data from different source positions and summing the results of the cross-correlation over a plurality of receiver locations, where the virtual receiver is at the position of one of the cross-correlated sources.

The present method is useful where the formation of interest lies on a line connecting two source positions and where the formation of interest does not lie on a line connecting two source positions. The source is preferably within 50 to 500 m of the formation of interest. The source may be randomly-transmitting.

The receivers may or may not be on the earth's surface, and may be buried.

In preferred embodiments, step b) comprises autocorrelating the data and summing the results of the autocorrelation over a plurality of receiver locations.

The data sets from a plurality of source positions can be processed so as to provide information selected from the group consisting of: images of the formation of interest, measurement of a property of the formation of interest, measurement of distance to the formation of interest, and combinations thereof.

### BRIEF DESCRIPTION OF THE DRAWINGS

For a more detailed understanding of the invention, reference is made to the accompanying wherein:

FIG. 1 is a schematic illustration of a prior art system;

FIG. 2 is a schematic illustration of a seismic system configured in accordance with the present invention;

FIG. 3 is a schematic illustration of the effective configuration of the system of FIG. 2 after creation of a virtual receiver at the drill bit position;

FIG. 4 is a schematic illustration of a technique for using the effective configuration of the system of FIG. 3; and

FIGS. 5 and 6 are schematic illustrations of a system in accordance with an alternative embodiment and the effective configuration of that system.

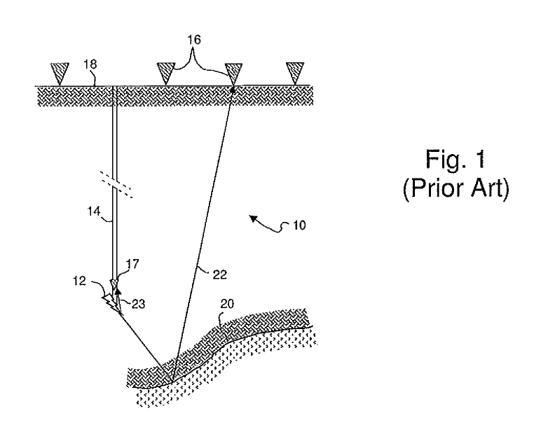

### DETAILED DESCRIPTION OF A PREFERRED EMBODIMENT

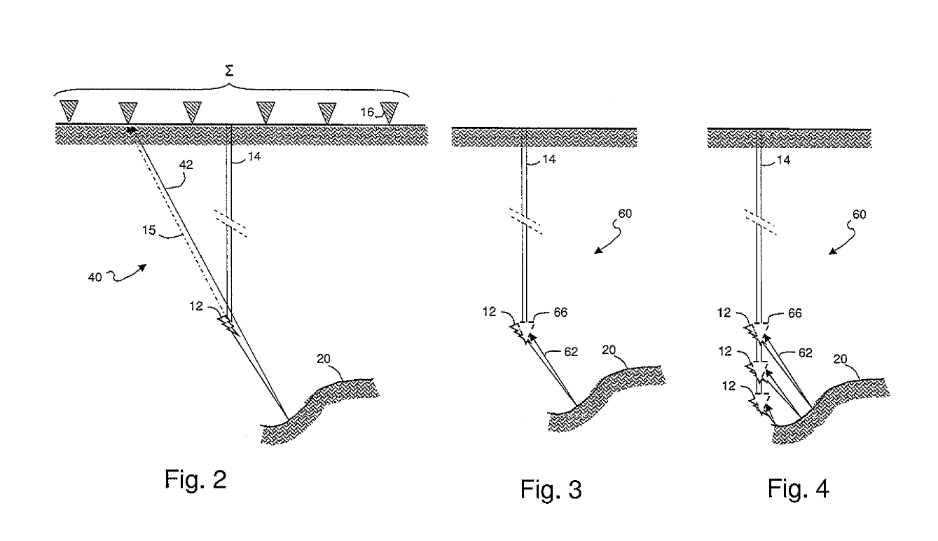

Referring initially to FIG. 2, one embodiment of the present invention includes a system 40 comprising a drill bit 12 in a borehole 14 and a plurality of receivers at the earth's surface. Receivers 16 record seismic signals that travel from bit 12 along various paths 42, including paths that include reflection by a subsurface reflector 20, as well as paths 15 that may partially coincide with the latter in the area between the drill bit 12 and receivers 16.

In one embodiment of the invention, the datasets comprising the seismic data collected at each of the receivers are cross-correlated, the results of the cross-correlation are summed over a plurality of receiver locations, and, optionally, deconvolved in order to shape the wavelet on the virtual trace. In preferred embodiments in which the source is the drill bit, the data is autocorrelated and the results of the autocorrelation are summed over a plurality of receiver locations.

As illustrated in FIG. 3, the resulting data creates a virtual receiver 66 (shown in phantom) at the location of the actual source (drill bit 12) and thus simulates a virtual system 60 in which the source and receiver are both located at the position of the bit. Seismic data recorded by a co-located source-receiver pair are commonly called ‘zero-offset’ seismic data. The virtual trace recorded in this case follows a path 62 from source 12 to virtual receiver 66. In addition to creating a new source/receiver geometry for the virtual data, the VR calculation also modifies the effective source signature—i.e., trace 62 now corresponds to an impulsive source at the location of the drill bit, and not to the original long-acting source (the drill bit). This is understood in any virtual source/receiver creation since, mathematically, the computation aims to reconstruct a band-limited version of the impulse response, also called Green's function, between two points (virtual source/receiver).

As will be understood in the art, there are various ways of processing the input data before cross-correlating. By way of example only, these include wavefield separation and appropriate time-gating, and, in some instances, amplitude weighting functions.

The process of collecting data and generating a virtual receiver trace is preferably repeated at multiple drill bit positions as illustrated in FIG. 4, in order to get a zero-offset virtual trace 62 at each bit position. Then the multi-trace zero-offset data set is preferably processed through a conventional VSP-type workflow to image reflectors ahead of or near the well.

While it is true that the bit is likely to be moving during collection of the seismic data, it is preferred that the data be collected over a sufficiently short time window that the change in the position of the bit can be ignored. For example, it is preferred that the bit move less than 100 feet, more preferably less than 50 feet, and more preferably less than 10 feet during one data collection window, and/or that one data collection window take less than 20-30 minutes. These preferred ranges depend on the rate of penetration (ROP) of the bit through the formation and will vary from well to well and with bit depth. If data are collected over longer periods, time-gating can be used to separate the data into batches so that each batch can be used to generate one zero-offset virtual trace.

This technique requires having a plurality, such as at least a line, of receivers either on the earth's surface or in an observation well. A preferred acquisition option would be to have an areal grid of receivers on the earth surface. The number and placement of the receivers are preferably optimized according to the expected imaging targets. Receiver spacing is preferably small enough to prevent aliasing of the drill bit noise.

In order to estimate the distance to the target reflector, as opposed to merely detecting its presence, it is necessary to use a known or estimated velocity value for the formation ahead of the bit. Typically, such velocity information is already available in the area of the well, for example from surface seismic data or from sonic logs or checkshots in nearby wells, Some uncertainty in the velocity value is acceptable because, with the drill bit close to the target reflector, that uncertainty will translate into a relatively small error in the computed distance to the reflector.

In instances where the target dip is known, the reflection moveout from one bit position to the next could be used to measure interval velocity along the well, but this is not typically a common situation. When the target dip is not known, the apparent velocity determined from the reflection moveout between two drill bit locations can be used as an upper bound of the true interval velocity between those locations.

The creation of virtual traces as described above allows the system to “look ahead” of the bit. Individual systems can be constructed with different targets in mind. The system described above and illustrated in FIGS. 2-4 is best suited for imaging reflectors that lie on an imaginary line connecting two source positions. Thus, for the common situation in which it is desired to illuminate horizontal or mildly dipping reflectors below the drill bit, it is preferable to place receivers at the earth's surface, which is easy and inexpensive.

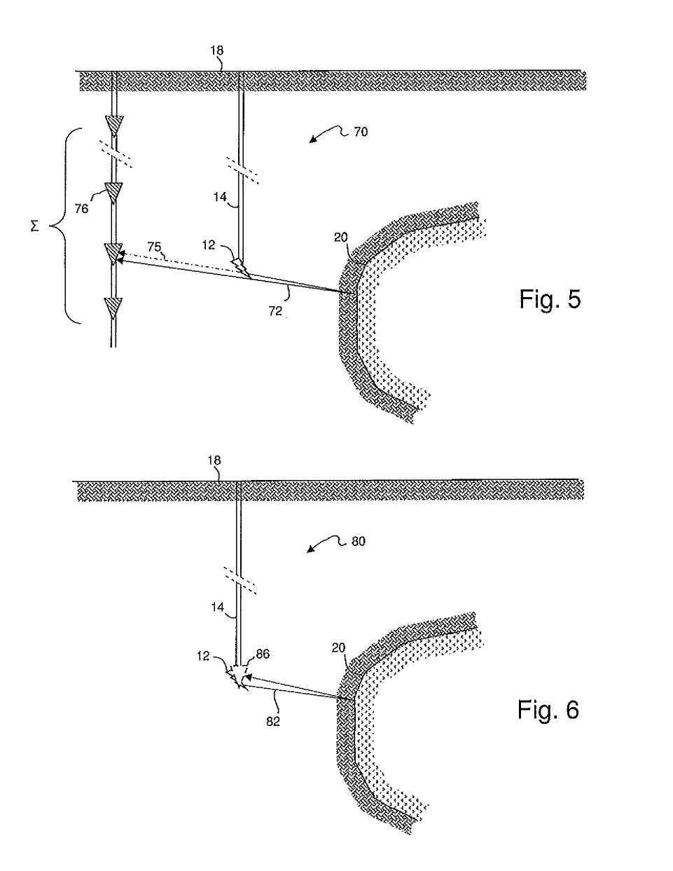

In contrast, for illuminating steep targets to the side of the drill bit, it may be preferable to place the receivers in an observation well on the opposite side of the active well, i.e., so that the drill bit is between the target and the receivers, as illustrated in FIGS. 5 and 6. In FIG. 5, a system 70 includes a drill bit 12 in a borehole 14 and a plurality of receivers 76 in a neighboring borehole. System 70 generates traces 72 and 75 that can be processed in the manner described above. The result is a virtual system 80 (FIG. 6) in which a virtual receiver 86 (shown in phantom) at the location of the actual source (drill bit 12) records traces that follow a virtual path 82 from source 12 to virtual receiver 86. As above, the collection of virtual trace data is preferably repeated for multiple source locations.

In preferred embodiments of the invention, the zero-offset virtual traces are processed so as to extract the desired reflections while suppressing noises and artifacts. For example, some artifacts are attributable to non-desirable sources of noise, i.e. other than the drill bit. It is expected that these artifacts will often be distinguishable from the desired signal on a multi-trace zero-offset gather because their timing is determined mainly by geology and field geometry and is insensitive to the drill bit position, thus these artifacts will appear at the same time on any zero-offset virtual trace. In contrast, the timing of the desired signals will change with drill bit position. Thus, in some embodiments, moveout can be used to separate desired events from noise in the multi-trace zero-offset gather. In particular embodiments, the virtual traces created at close consecutive drill bit positions can be subtracted from each other in order to suppress common artifacts and enhance the signal.

The present invention allows quick, efficient, and effective collection of images of reflectors ahead of the bit and is particularly useful for imaging horizontal reflectors below a vertically-drilling well. In order to collect the images, it is not necessary to interrupt drilling or to place receivers in the active well, nor to have any special synchronization or communication between downhole and surface equipment. The data generated according to the present techniques can be processed to provide a variety of information including, but not limited to: images of the formation of interest, measurement of a property of the formation of interest, measurement of distance to the formation of interest, and combinations thereof.

While the present invention has been described and disclosed in terms of preferred embodiments, it will be understood that various modifications could be made without departing from the scope of the invention, which is set out in the claims that follow. For example, the number and configuration of receivers, well depth and position, reflector type, can each be varied and may be different from the Figures, which are merely schematic illustrations. Likewise, while the invention is disclosed in terms of a system in which the drill bit serves as a seismic source, it will be understood that the benefits of the invention can be derived if the seismic source is not the bit, but is otherwise located in the borehole and preferably, but not necessarily, adjacent to or near the bit.

1. A method of evaluating a formation of interest, comprising:
a) collecting a data set comprising signals received at a plurality of receivers from a source on a bottom-hole assembly at a position in a borehole;
b) processing the data set so as to create a virtual trace received at a virtual receiver located at the source position; and
c) using the virtual trace to generate an image or measurement containing information about the formation of interest.

2. The method according to claim 1 wherein the source position is within 50 feet of a predetermined depth.

3. The method according to claim 1 wherein the source moves less than 100 feet during step a).

4. The method according to claim 1, further including repeating steps a)-b) for at least one additional source position in the borehole.

5. The method according to claim 4 wherein the additional source position is less than 50 feet from the previous source position.

6. The method according to claim 4, further including finding the difference between at least a pair of virtual traces generated at source positions less than 10 feet apart.

7. The method according to claim 1, further including repeating steps a)-b) at least 5 times within 200 feet.

8. The method according to claim 1 wherein there are no receivers in the same well as the source.

9. The method according to claim 1 wherein the source is a drilling tool or a drill bit.

10. The method according to claim 9 wherein the formation of interest is ahead of the bit.

11. The method according to claim 9, further including using time-gating on the received signals to separate the source positions.

12. The method according to claim 1 wherein the source is not the drill bit and is an acoustic transmitter on the bottom hole assembly.

13. The method according to claim 12, further including using at least one method selected from the group consisting of: wavefield separation, time-gating, and combinations thereof on the received signals to improve the virtual trace results.

14. The method according to claim 12 wherein step c) comprises cross-correlating the data and summing the results of the cross-correlation over a plurality of receiver locations.

15. The method according to claim 12 further including collecting data from a plurality of source positions and includes cross-correlating the data from a plurality of source positions.

16. The method according to claim 1 wherein the source is randomly-transmitting.

17. The method according to claim 1 wherein the receivers are on the earth's surface.

18. The method according to claim 1 wherein the receivers are not on the earth's surface.

19. The method according to claim 1 wherein step b) comprises autocorrelating the data and summing the results of the autocorrelation over a plurality of receiver locations.

20. The method according to claim 1, further including after step c) processing the resulting data sets from a plurality of source positions so as to provide information selected from the group consisting of: images of the formation of interest, measurement of a property of the formation of interest, measurement of distance to the formation of interest, and combinations thereof.
